(19) United States
(12) Patent Application Publication
(10) Pub. No.: US 2015/0331125 A1
(43) Pub. Date: Nov. 19, 2015

(54) METHOD FOR CALCULATING A SEISMIC SURVEY

(71) Applicant: Sercel, Carquefou (FR)

(72) Inventors: Fabien Chene, Guerande (FR); Didier Renaud, Nantes (FR)

(21) Appl. No.: 14/677,546

(22) Filed: Apr. 2, 2015

Related U.S. Application Data
(60) Provisional application No. 61/996,675, filed on May 14, 2014.

(51) Int. Cl. G01V 1/38

(52) U.S. Cl. CPC G01V 1/3808; G01V 2210/1212; G01V 2210/1293

(57) ABSTRACT

Non-constant spatial parameters and/or temporal parameters are assigned respectively to at least one input shot sequence and shot time predictions commuted from a shot sequence, giving flexibility for how and where to shoot during a multi-source survey.

### 1. CROSS-REFERENCE TO RELATED APPLICATION

The present application is based on and claims the benefit of U.S. provisional patent application Ser. No. 61/996,675, filed May 14, 2014, the content of which is hereby incorporated by reference in its entirety.

### 2. FIELD OF THE DISCLOSURE

The field of the disclosure is that of marine seismic prospection, enabling to study the different layers of the earth crust.

More specifically, the disclosure relates to a method for managing shots performed by seismic sources towed by seismic vessels during a seismic acquisition, also called seismic survey, to give flexibility in how to perform the shots.

The disclosure can be applied notably to the oil prospecting industry using seismic method, but can be of interest for any other field implementing a seismic data acquisition network.

### 3. TECHNOLOGICAL BACKGROUND

To perform a marine seismic acquisition in a survey area, it is common to use seismic sources (like “air guns”, “vibratory sources”, . . . ) and seismic sensors. The sensors are housed in cables, called streamers (or acoustic linear antennas or seismic cables). Several streamers are used together to form an array of thousands of sensors. Sources are towed by one or several vessels, and streamers are towed by one or several vessels. A same vessel can tow both sources and streamers (i.e. can tow one or several streamers and one or several seismic sources).

To collect the geophysical data in the marine environment, the seismic sources are activated to generate single pulses or continuous sweep of energy. The signals generated by each source travels through the different layers of the earth crust and the reflected signals are captured by the sensors (hydrophones) in the streamers. By processing the signals captured by the hydrophones, geophysicists are able to achieve an imaging of the different layers of the earth crust.

A seismic source should shoot at a shot point (also referred to as “shot point”), defined by its geographical coordinates (latitude/longitude and/or easting northing). When the seismic source towed by a vessel reaches this shot point, the seismic source is activated and produces an explosion. The set of shot points of all seismic sources is called “preplot”.

The marine seismic acquisition is controlled and monitored by a navigation system (also referred to as INS, for “Integrated Navigation System”), which is onboard each vessel. Each INS of a vessel allows calculating position of sensors and seismic sources and driving the vessel along its acquisition path, according to a predetermined preplot, and to activate seismic sources to perform seismic acquisition at desired shot points of the preplot.

The navigation system also determines the moment of firing a source for each shot point, according to the positions of the various system components. This moment of firing is referred to as “shot time”.

To further increase the quality of the imaging of the different layers of the earth crust, the seismic surveys can be performed with a plurality of vessels. Such a survey is referred to as “multi-vessel” survey. This type of survey allows obtaining a “wide azimuth” illumination of the different layers of the seabed earth crust, according to a preplot referred to as “wide azimuth preplot” or “WAZ preplot”.

In a multi-vessel survey, it is common to select a specific vessel among the plurality of vessels and referred it to as a “master vessel”. This master vessel is a reference vessel and the reference of time of each other vessels thanks to its INS. Each other vessel is referred to as “slave vessel” and is synchronized on the reference of time of the master vessel.

So that the shooting order is complied, the various vessels should be synchronized. The shooting order of the sources is defined by the preplot and should be performed as close as possible to the geographic coordinates of the shot points specified in the wide azimuth preplot.

The wide azimuth preplot is defined by a plurality of sequences of shot points, also called “shot sequences”, where the shots of the various vessels are interlaced.

A major drawback of the multi-vessel surveys based on a master vessel (also referred to as “centralized mode”) is that the survey has to be stopped if the master vessel is not able to perform its survey, for any reason, because of the synchronization of each slave vessel with the master vessel.

Indeed, each shot predictions of each slave vessel are based on the shot predictions of the master vessel. In a simultaneous shooting configuration where each vessel has to shoot at the same time, for one shot point to shoot at a time T0 by the master vessel along the master vessel's preplot, each slave vessel has to shoot at T0+ΔT so as to perform this simultaneous shooting survey, ΔT being a parameter which allows to take account of the random dithering and jittering to perform a best seismic data post processing. Such configuration is referred as a “theoretical” simultaneous shooting and suffers from a lack of flexibility. Indeed, each slave vessel has to shoot at a fixed time even if this time to shot is not optimal to perform such a simultaneous shooting survey.

Moreover, according to current solutions, one shot “coerces” all the other, i.e. all shots of slave vessels are based on the shots of the master vessel.

Another drawback of current solutions is that the preplot geometry is restrictive and not customizable. Indeed, a predetermined distance (for example 20 meters) should be respected between two consecutive shots of the shot sequence. Thus, no flexibility in term of shooting predictions is allowable, in a multivessel survey or in a “single” vessel survey (in which only one vessel perform the survey according to its shot sequences).

Finally, these current solutions do not minimize the sources “distances along” (i.e. the distance between the predicted shot point and the point where the shot is actually done).

### 4. SUMMARY

A particular embodiment of the disclosure proposes a method for calculating a multi-source seismic survey, wherein said method comprises a step of obtaining at least a shot sequence wherein each shot is associated to one source of said multi-source seismic survey and one source may be associated to more than one shot, and at least one of the following steps or a combination of the following steps:
Assigning at least one spatial parameter, corresponding to a non-constant spatial constraint, to at least one shot in said obtained shot sequence, delivering an adapted shot sequence;
Assigning at least one temporal parameter to at least one shot predictions computed from said obtained shot sequence or from said adapted shot sequence, delivering adjusted shot time predictions.

Thus, this particular embodiment of the disclosure relies on a wholly novel and inventive approach of calculating a multi-source seismic survey, in which new parameters are used to extend the parameter's set (present for example in the preplot file used as input) related to a shot sequence.

These new parameters offer the ability to specify an irregular geometry concerning the shot points in a multi-vessel context, by defining non-constant spatial constraints (also called spatial parameters) applied to one or more shots in a sequence and/or defining temporal constraints (also called temporal parameters) applied to shot predictions computed from one or more shot sequences. Thus, this particular embodiment of the disclosure allows building shot points in an arbitrary manner.

To achieve such a customizable preplot geometry, it is first proposed to allow a source to shoot more than once in a shooting sequence. Then, given such a shooting sequence, each item of the sequence (i.e. each shot) is associated to a source.

According to a first embodiment, given such a shooting sequence, each item of the sequence (i.e. each shot) is associated to a spatial parameter, which can be for example a relative spatial offset (associated or not with a bearing) from a predetermined reference point along the preplot, delivering an adapted shooting sequence.

For example, the reference point corresponds to the beginning of the sequence.

These relative spatial offsets thus allow simultaneous shots (from two or more sources), in case the relative offset associated to two (or more) shots is the same.

In other words, this particular embodiment of the disclosure allows a synchronization of sources relative to each other, and no more a synchronization of a source with respect of a “master” one, as in known solutions.

The spatial parameters, according to the different embodiments of the disclosure, are called “non-constant” because such an adapted shot sequence may present as many different offset values as the number of item in the sequence, giving a greater flexibility to the survey processing, thanks to this embodiment of the disclosure.

Thus, an adapted sequence will have more parameters than known in the art: a shooting sequence length (optionally), a number for each shot and the associated source number, the number of the reference point, a spatial parameter assigned to at least a shot number.

According to a second embodiment, given such a shooting sequence, shot time predictions are computed, as a function of the speed, the position and the direction of the vessel(s) towing the source(s), and temporal parameters are applied to these shot time predictions, delivering adjusted shot time predictions. Thus, applying these temporal parameters allows correcting potential drifts and offset delays as the progress of the vessels (for example when vessels do not respect, during the survey, the predefined vessels formation). It also provides the ability to specify a minimum shot interval (a common temporal constraint) on subparts of a line or on the whole line, optimizing therefore the survey by providing a more optimal speed, which is deduced from the minimum shot interval.

According to a third embodiment, the temporal constraints are computed by taking account of the non constant spatial parameters previously applied to the shot sequence, also delivering adjusted shot time predictions. For example, temporal parameters can be computed from a spatial offset and a theoretical speed previously defined for one or more source vessels.

Thus, an updated shot sequence will have more parameters than known in the art: a shooting sequence length (optionally), a number for each shot and the associated source number, the number of the reference point, a spatial parameter assigned to at least a shot number, at least one temporal parameter assigned to at least one shot time predictions related to this updated shot sequence.

According to this particular embodiment, applying temporal parameters allows shooting at the good position, shooting with a high frequency and/or with an irregular “STI”, even between close shots.

It also allows shooting a shot numbered 2 of a shot sequence before a shot numbered 1 in same sequence, if needed (for example to respect a spatial constraint).

In any cases, computation of temporal constraints, based on non-constant spatial parameters, ensures that all these both parameters in the sequence are coherent. For that, a device such as an optimizer or a “pseudo-optimizer”, or a “constraints complier” or “pseudo-constraints complier” . . . .

In a particular embodiment, said non-constant spatial parameters and said temporal parameters are:
Predetermined before said survey while computing the preplot, or
Generated at line submission, or
Computed during said survey while performing the shot time predictions, or
At least a combination of some of these aforesaid situations.

In a particular implementation, said temporal parameters are defined by at least two variables corresponding to a type and a value.

According to this particular embodiment, at least a type and a value define a temporal parameter.

The type of the temporal parameter allows defining minimum or maximum values, range values, fixed values . . . .

In the following, one of the types of temporal parameter is called “STI”, for “Short Time Interval”.

The value of the temporal parameter is related to the type of the temporal parameter.

According to a particular feature, said temporal parameters are defined by at least a couple of indexes, each index referring to a particular shot in said adapted shot sequence.

According to this particular embodiment, a temporal parameter also comprises a couple of indexes, referring to the related shot sequence, in order to associate a temporal parameter to a particular range of shots in the related shot sequence (from which the shot time predictions have been computed), adapted or not according to whether the temporal parameters are combined with spatial parameters.

For example, said steps of obtaining and assigning are performed at least twice during said survey.

According to this particular embodiment, an updated shot sequence, as well as adjusted shot time predictions, may be obtained at any time during a survey, in a dynamical manner, and the preplot can be calculated periodically, using the updated shot sequence.

An updated shot sequence delivered a first time, in a survey, can be used as the obtained shot sequence a second time, and so on.

In another embodiment, the disclosure pertains to a computer program product comprising program code instructions for implementing the above-mentioned method (in any of its different embodiments) when said program is executed on a computer or a processor.

In another embodiment, the disclosure pertains to a non-transitory computer-readable carrier medium, storing a program which, when executed by a computer or a processor causes the computer or the processor to carry out the above-mentioned method (in any of its different embodiments).

In another embodiment, the disclosure pertains to a calculating device for calculating a multi-source seismic survey, wherein said calculating device comprises an input module configured to obtain at least a shot sequence wherein each shot is associated to one source of said multi-source seismic survey and one source may be associated to more than one shot, and at least on of:
A spatial parameter assigning module configured to assign at least one spatial parameter, corresponding to a non-constant spatial constraint, to at least one shot in said obtained shot sequence, delivering an adapted shot sequence;
A temporal parameter assigning module configure to assign at least one temporal parameter to at least one shot predictions computed from said obtained shot sequence or from said adapted shot sequence, delivering adjusted shot time predictions.

Advantageously, the device comprises means for implementing the steps it performs in the process as described above, in any of its various embodiments.

### 5. LIST OF FIGURES

Other features and advantages of embodiments of the disclosure shall appear from the following description, given by way of an indicative and non-exhaustive examples and from the appended drawings, of which:

FIG. 1 is a flowchart of a first particular embodiment of the method according to the disclosure;

FIG. 2 illustrates a first example of application of the first particular embodiment of the method according to the disclosure;

FIGS. 3a and 3b illustrate a second example of application of the first particular embodiment of the method according to the disclosure, respectively after the step of obtaining a shot sequence (FIG. 3a) and after the step of assigning non-constant spatial parameters (FIG. 3b);

FIGS. 4a to 4d illustrate a third example of application of the first particular embodiment of the method according to the disclosure, respectively in case of vessels respecting their initial configuration and in case of one vessel not respecting its initial configuration;

FIG. 5 illustrates an example of application of a second particular embodiment of the method according to the disclosure, with the assigning of temporal parameters;

FIG. 6 shows the simplified structure of a calculating device according to a particular embodiment of the disclosure.

### 6. DETAILED DESCRIPTION

In all of the figures of the present document, the same numerical reference sign designates identical elements and steps.

One or more different embodiments of the disclosure can be applied to a multi-source survey, involving one vessel (only one vessel tows a plurality of sources, each source following a different path, or the same path, according to the sail line of the vessel) or many vessels (for example in a well-known “centralized” multivessel configuration comprising a master vessel and one or many slave vessels, each shot of a slave vessel depending of at least one shot of said master vessel). It also can be applied to simultaneous shooting, as well as not simultaneous shooting.

The general principle of an exemplary embodiment is that of assigning spatial constraints to at least one shot in a shot sequence of a preplot, in order to obtain an adapted shot sequence. Such adapted shot sequences allow taking account of an irregular geometry of the shot points, as the spatial parameter may differ from one shot to another.

This principle is first based on the association of a source to each shot of a shooting sequence and secondly based on the ability to allow a source more than once in such a shooting sequence.

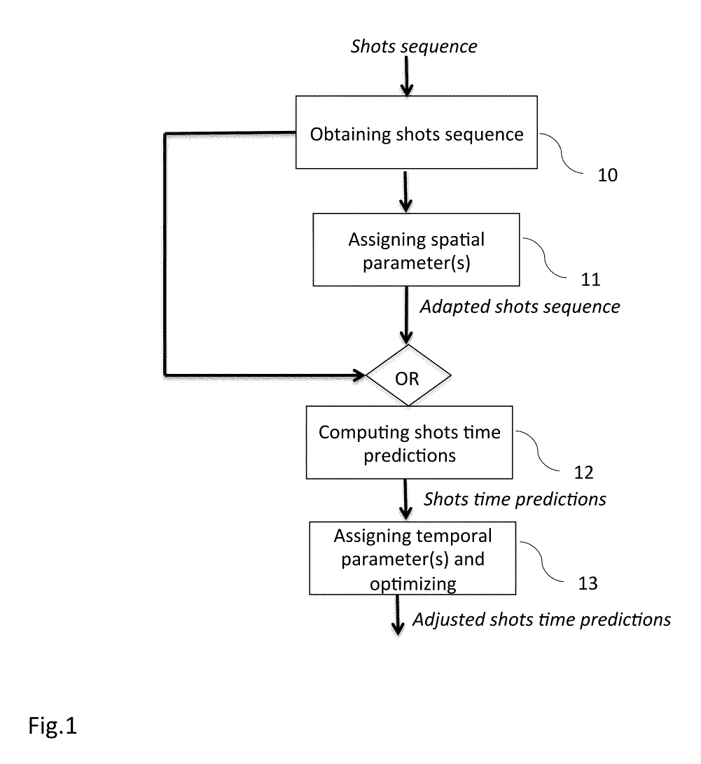

Referring now to the flowchart of FIG. 1, we present a first particular embodiment of the method according to the disclosure (upper part of FIG. 1). When executed by a calculating device (see FIG. 7 described below), this method automatically assigns a spatial parameter to at least one shot of a shot sequence used as input, thus delivering an adapted shot sequence.

In step 10, at least one shot sequence is provided to a calculating device, wherein each shot is associated to one source and one source may be associated to more than one shot. Such a shot sequence comes from a preplot file used in input, and already presents associations between each shot and a source.

Considering for example a shot sequence of six shots (1001, 1002 . . . 1006), involving three distinct sources (S1, S2 and S3), such a shot sequence may be defined as following, in order to represent the “shot-source” associations:

{(1001-S1), (1002-S2), (1003-S1), (1004-S3), (1005-S2), (1006-S3)}.

In this example, one can see that each source is repeated twice in the shot sequence.

Then, referring again to FIG. 1, in step 11, the calculating device assigns a spatial parameter to at least one shot of the shot sequence and delivers an adapted shot sequence. In a particular variant of this first embodiment, such a spatial parameter corresponds to a relative spatial offset, from a predetermined reference point pertaining to the shot sequence.

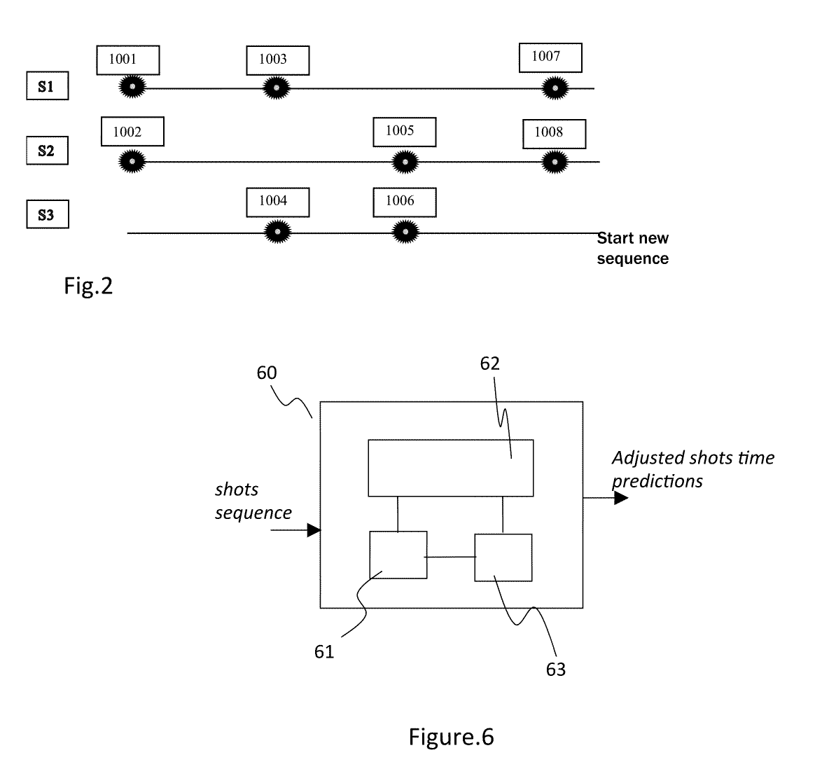

According to this first embodiment, a spatial parameter can be a relative offset assigned to a shot, which is illustrated by a point on a discretised waypoint path. This is illustrated for example in FIGS. 2, 3a, 3b, 4b and 5.

According to variants for this embodiment, a spatial parameter can also be a relative offset associated with a bearing.

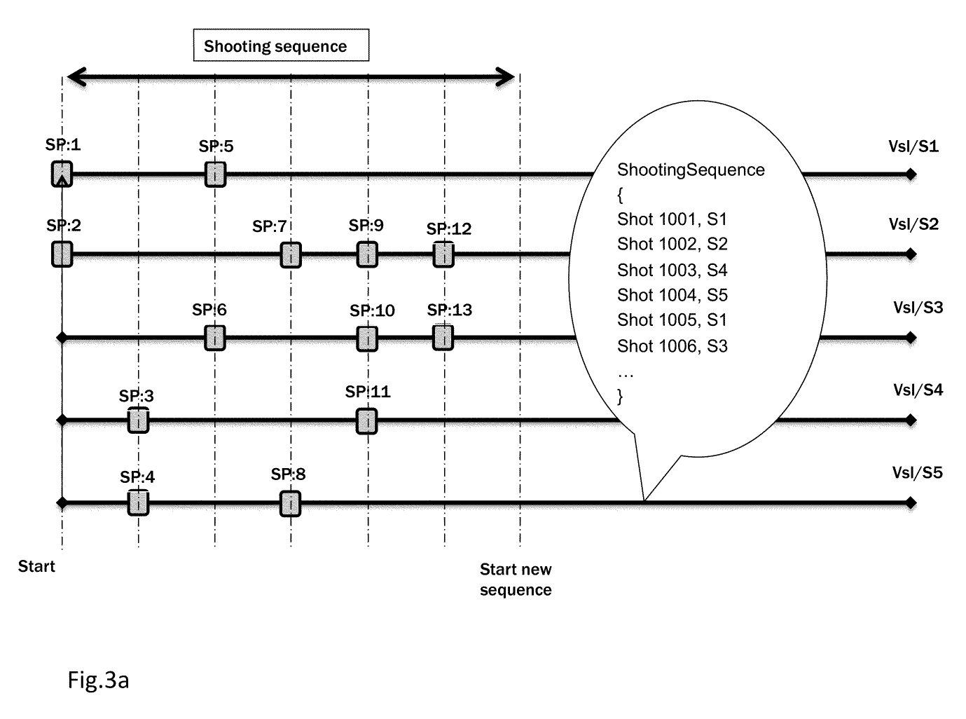

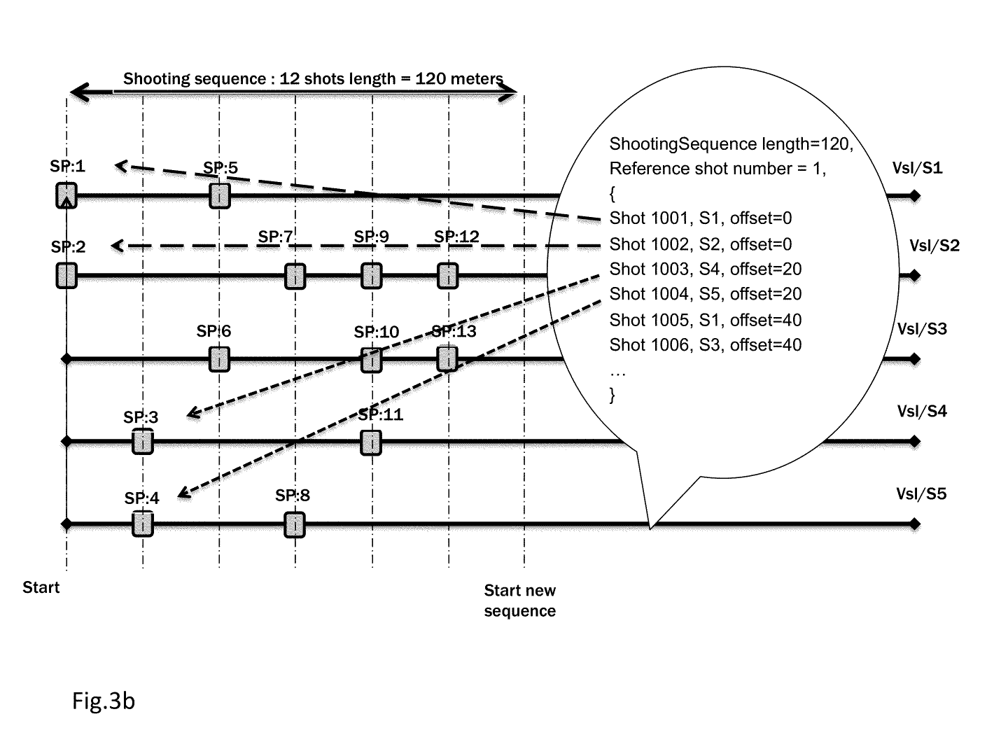

An additional attribute giving the length of the adapted shot sequence may also be associated to it, thus allowing defining a shooting pattern according to the length of the sequence. This shooting pattern can thus be repeated a predetermined number of times. This feature is also illustrated in FIGS. 2, 3a and 3b.

Such an adapted shot sequence may be defined as following, in order to represent the “shot-source” associations as well as the spatial parameter assignments:

{(1001-S1-0), (1002-S2-0), (1003-S1-x), (1004-S3-x), (1005-S2-2x), (1006-S3-2x)}.

In this configuration, shots 1001 and 1002 are shot simultaneously, with a null spatial parameter (i.e. shots are shot at the beginning of the line), and likewise for shots 1003 and 1004 (with a spatial offset equal to x), for shots 1005 and 1006 (with a spatial offset equal to 2x), and so on with an adapted shot sequence beginning again with shots 1007 and 1008, as illustrated in FIG. 2.

The simultaneous shots are obtained, in this example, thanks to the spatial offsets assigned to each shot, thus allowing each shot point to be computed from a reference point and a relative offset, and not from a master vessel position as in the background solutions.

Thanks to these non-constant assigned spatial parameters, more flexibility is given for each time to shot of a shot sequence. Thus, more flexibility is also given to perform the preplot. Thanks to this particular embodiment, one can decide to fire before or after a time to shoot T0 of a predetermined preplot, and not only at a fixed time T′0=T0+Δt as discussed below.

Referring now to FIGS. 3a and 3b, we present a second example of application of this first particular embodiment of the method according to the disclosure, respectively after the step of obtaining a shot sequence of a preplot (FIG. 3a) and after the step of assigning non-constant spatial parameters (FIG. 3b).

In this example, five sources (S1, S2, . . . S5) are involved, on five or less number of vessels (i.e. a vessel may tow more than one source), and the shot sequence (or shooting sequence) comprises thirteen shots (1001, 1002, . . . 1013) located on thirteen shot points (SP1, SP2, . . . SP13). These characteristics are for example parameters from a preplot used as input for the obtaining step 11 illustrated in FIG. 1.

Each source of the input shot sequences is associated to shot(s), as following: {(1001-S1), (1002-S2), (1003-S4), (1004-S5), (1005-S1), (1006-S3) . . . }, as illustrated in FIG. 3a.

Then, referring now to FIG. 3b and according to the first embodiment, a length of 120 meters is attributed to the obtained shot sequence, the reference shot number corresponds to the first shot, and a spatial parameter (in meter) is assigned to each shot of the sequence, the assigned spatial parameter can be different for each shot.

The adapted shot sequence can thus be defined as following:

```
  {Shooting sequence length = 120,
  Reference shot number = 1,
  { (1001-S1-offset=0) , (1002-S2-offset=0) , (1003-S4-offset=20) ,
(1004-S5-offset=20) ,
  (1005-S1-offser=40) , (1006-S3-offset=40) , ...}
  }.
```

As it can be seen in FIGS. 3a and 3b, sources 1 and 2 shoot simultaneously the shots 1001 and 1002, with a null offset compared to the reference shot number (i.e. the beginning of the sequence), then sources 4 and 5 shoot simultaneously the shots 1003 and 1004, with an offset of 20 meters compared to the reference shot number, and sources 1 and 3 shoot simultaneously the shots 1005 and 1006, with an offset of 40 meters compared to the reference shot number . . . and so on until the end of the sequence (120 meters). Then, an adapted shot sequence starts again to perform the full preplot.

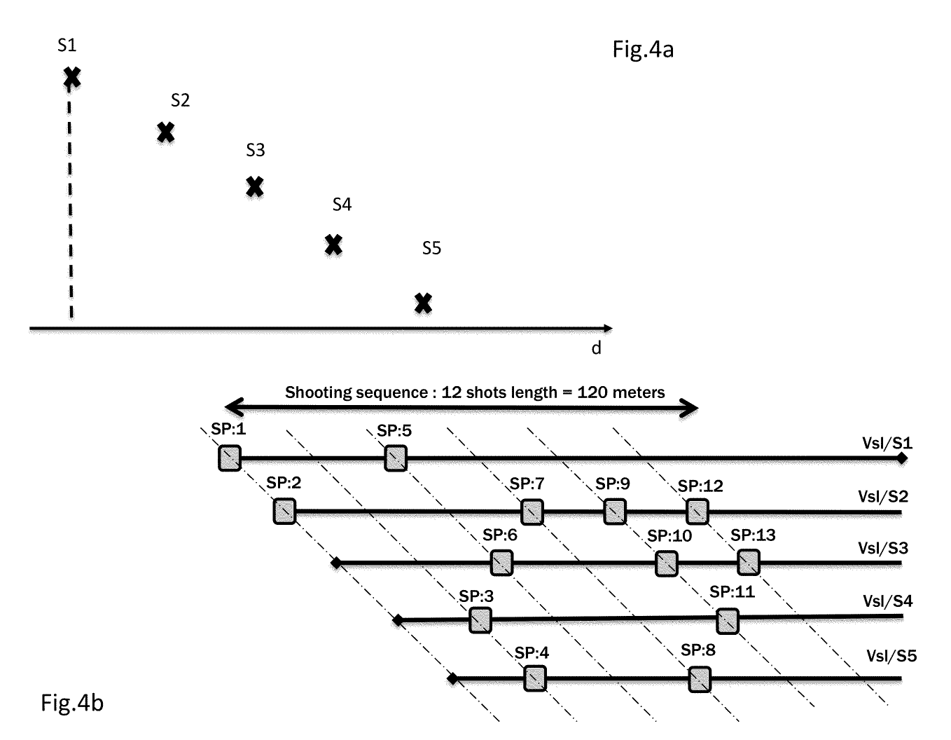

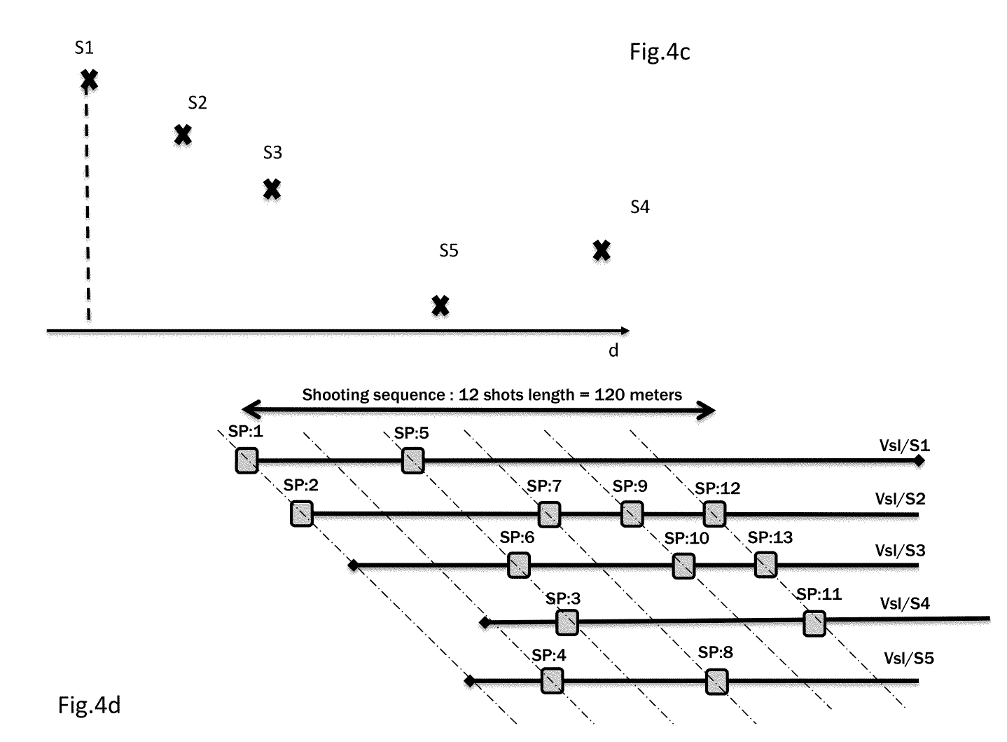

The shooting precision, as well as the simultaneous shooting, is also obtained, in this example, thanks to the spatial offsets assigned to each shot, thus allowing each shot point to be computed from a reference point and a relative offset, and not from a master vessel position as in the background solutions. This can be illustrated in FIGS. 4a and 4b, wherein the vessels respect, during the survey, the initial configuration.

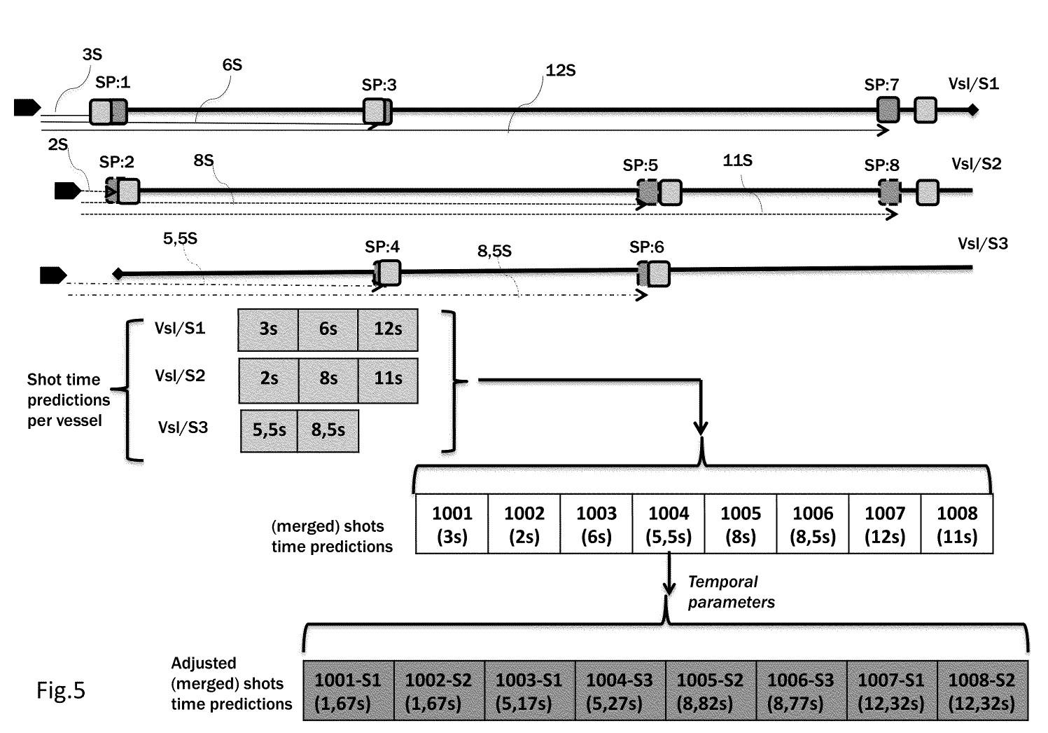

Thus, this first embodiment is optimal if each vessel of the fleet starts at the expected time and position defined by the preplot. However, if a vessel does not respect the preplot requirements, as in FIGS. 4c and 4d (S4, corresponding to vessel 4, has started too early), the use of other parameters are required as explained below in a third embodiment of the disclosure in relation with the FIG. 5 (described in details hereinafter).

We present a second particular embodiment of the method according to the disclosure, wherein temporal constraints are assigned, as temporal parameters, to at least one shot time prediction computed from said obtained shot sequence and from vessels information (position, speed . . . ), delivering adjusted shot time predictions.

Assigning temporal parameters to shot time predictions allows taking account of temporal constraints during the survey, like a respect of a minimum interval between two successive shots (also called “min STI” for “Minimal Shot Time Interval”), thus optimizing the optimal speed that is deduced from the minimum shot interval.

A temporal parameter is defined by at least two variables: a type and a value.
The type allows defining minimum or maximum values, range values, fixed values . . . .

For example, one of the types of temporal parameter is called “STI”, for “Short Time Interval”.

The value of a temporal parameter can be predetermined (for example fixed in the preplot used as input), generated at line submission, or evaluated while performing the shot time predictions (from the shot sequence).

A temporal parameter optionally comprises a couple of indexes, referring to the related shoots sequence. For example, each of the indexes in the couple represents a shot number, thus defining a shot range.

Here are examples of such temporal parameters, wherein a temporal parameter is assigned, with a type and a value in seconds for example, to each shot range of a shot sequence (from shot 0 to shot 6, including the last range from shot 6 to shot 0 of a new shot sequence):

<type=fixedSTI, value=0, index_from=0, index_to=1/>: means that there should be no delay between the two shots of the range [0,1], i.e. between shot 0 and shot 1;

<type=minSTI, value=10, index_from=1, index_to=2/>: means that a minimum Shot Time Interval of 10 seconds should be respected between the two shots of the range [1,2], i.e. between shot 1 and shot 2;

<type=fixedSTI, value=0.2, index_from=2, index_to=3/>: means that a Shot Time Interval of 0.2 seconds should be respected between the two shots of the range [2,3], i.e. between shot 2 and shot 3;

<type=minSTI, value=auto, index_from=3, index_to=4/>

<type=fixedSTI, value=random(−0.1,0.1), index_from=4, index_to=5/>: means that a Shot Time Interval having a value randomly determined in the range (−0.1 seconds-0.1 seconds), should be respected between the two shots of the range [2,3], i.e. between shot 2 and shot 3;

<type=minSTI, value=10, index_from=5, index_to=6/>;

<type=minSTI, value=12, index_from=6, index_to=0/>.

An “auto” value is dynamically determined and not known at the time of the creation of the preplot (before the beginning of the survey), whereas a “random” value is determined at line submission.

In a third embodiment, referring now to FIG. 5, and the lower part of FIG. 1, such temporal parameters can be computed from the non-constant spatial offsets previously assigned to each shot. In that case, the temporal parameters are applied to at least one shot time prediction computed from the adapted shot sequence, thus combining temporal and spatial parameters.

According to this third embodiment:
non-constant spatial parameters are applied to at least one shot sequence, delivering at least an adapted shot sequence (steps 10 and 11);
temporal parameters are defined from these non-constant spatial parameters;
shot time predictions are computed from the adapted shot sequence and vessel(s) information (step 12);
the previously defined temporal parameters are taking into account in an optimization device, also named an optimizer or a “pseudo-optimizer”, or a “constraints complier” or “pseudo-constraints complier”, delivering adjusted shot time predictions (step 13).

Typically, if we consider two shot points with a fixed “STI” temporal parameter (as defined according to known methods) and a theoretical speed planned at 2.5 m/s:
if the spatial offsets associated to the two shot points are equal, the value of the fixed time temporal parameter will be equal to 0 s;
if the spatial offsets associated to the two shot points differ from 0.5 m, the value of the fixed time temporal parameter will be equal to 0.2 s.

Referring now again to FIG. 5, we consider three sources (S1, S2 and S3), on three or less vessels, and their associated shot time predictions:
S1: 3 seconds for its first shot, 6 seconds for its second shot and 12 seconds for its third shot;
S2: 2 seconds for its first shot, 8 seconds for its second shot and 11 seconds for its third shot;
S3: 5.5 seconds for its first shot and 8.5 seconds for its second shot.

The shot points corresponding to these shot time predictions are illustrated in dark grey in the upper part of FIG. 5.

Then, a merged is defined as following, considering eight shots:

{1001 (3 s), 1002 (2 s), 1003 (6 s), 1004 (5.5 s), 1005 (8 s), 1006 (8.5 s), 1007 (12 s), 1008 (11 s)}.

According to the first embodiment of the present disclosure, non-constant spatial parameters (determined for example at the time of construction of the survey) are assigned to each shot of the shot sequence, delivering an adapted shot sequence, with a length of 120 meters, as following:

{Shooting sequence length = 120;
Reference shot number = 1;
{
(1001-S1-offset=-0,1),
(1002-S2-offset=0,2),
(1003-S4-offset=11,95),
(1004-S5-offset=12,15),
(1005-S1-offset=24,25),
(1006-S3-offset=23,97) , ...}
}.

Then, according to the second embodiment of the disclosure, temporal parameters (for example defined from the spatial parameters) are applied to respect the following constraints:
Shots 1001 and 1002 need to be nearly simultaneous;
Delay between shots 1003 and 1004 needs to be equal to 0.1 s;
Delay between shots 1006 and 1005 needs to be equal to 50 ms;
Shots 1007 and 1008 need to be simultaneous;
A STI greater than 3.5 s needs to be applied between shots 1002 and 1003, shots 1004 and 1006 and shots 1005 and 1007.

All of this gives the following temporal parameters to be assigned to some of the shot time predictions computed from the adapted shot sequence:
A fixed STI of 0.2 s between shot 1001 and 1002;
A minimum STI of 6 s between shot 1002 and 1003;
A fixed STI of 0.1 s between shot 1003 and 1004;
A minimum STI of 6 s between shot 1004 and 1005;
A fixed STI of −0.15 s between shot 1005 and 1006;

. . .

The temporal parameters allow flexibility during the survey, because in that case, it is not required that the vessels respect their initial configuration to run on a survey.

Finally, a shot sequence comprising non-constant spatial parameters and temporal parameters applied to shot time predictions can be defined as following:

{Shooting sequence length = 120;
Reference shot number = 1;
{
(1001-S1-offset=-0,1),
(1002-S2-offset=0,2),
(1003-S4-offset=11,95),
(1004-S5-offset=12,15),
(1005-S1-offset=24,25),
(1006-S3-offset=23,97),
...}
};
{
(temporal parameter type=fixedSTI, value=0,2, index_from=0, index_to=1),
(temporal parameter type=minSTI, value=6, index_from=1, index_to=2),
(temporal parameter type=fixedSTI, value=0.1, index_from=2, index_to=3),
(temporal parameter type=minSTI, value=6, index_from=3, index_to=4),
(temporal parameter type=fixedSTI, value=-0,15, index_from=4, index_to=5),
...}.

Moreover, the time to shot corresponding to this shot sequence is illustrated in the lower part of FIG. 5 (with the corresponding adjusted time shot predictions in light grey in the upper part of this FIG. 5):
1.67 s for shots 1001 and 1002;
5.17 s for shot 1003;
5.27 s for shot 1004;
8.82 s for shot 1005;
8.77 s for shot 1006;
12.32 s for shots 1007 and 1008.

It is to be noted that the combination of these “non-constant” spatial parameters with these temporal parameters allow giving flexibility for how and where to shoot.

Moreover, in a simultaneous shooting, using such temporal parameters allows giving more flexibility by counterbalancing the non-respect of the vessel formations of at least one vessel of the fleet, in order to ensure much more simultaneity between the shots that should be simultaneous.

According to different variants of the disclosure, temporal parameters and spatial offsets can be arbitrarily defined by the user, or partially or all computed by an automated process.

Spatial and temporal parameters can be computed before the survey, or dynamically at the beginning of the survey or during the survey, by taking account of certain characteristics of the survey as:
Ground and water properties, such that theoretical time to transmit sound on the survey area (ground and water), theoretical sound dispersion and propagation model, or any other ground and water physical properties;
Defined geometry of the vessel (relative offset between vessels and towed equipment's);
Sea floor definition;
Specified depth observation.

In any cases, computation of temporal parameters and/or spatial offsets ensures that these parameters are coherent in a shot sequence.

Thus, the disclosure, according to one or more different embodiments, provides for an optimal survey, in any conditions of alignment for the vessels.

FIG. 6 shows the simplified structure of a calculating device 60 according to a particular embodiment of the disclosure. The calculating device is for example a module of central unit of a seismic system.

The calculating device 60 comprises a non-volatile memory 61 (e.g. a read-only memory (ROM) or a hard disk), a volatile memory 63 (e.g. a random access memory or RAM) and a processor 62. The non-volatile memory 61 is a non-transitory computer-readable carrier medium. It stores executable program code instructions, which are executed by the processor 62 in order to enable implementation of the method described above (method for calculating a seismic survey), in relation with FIGS. 1 to 5.

The calculating device 60 receives (obtains) a shot sequence (see step 10 in FIG. 1) and generates assignments of at least one spatial parameter to at least one shot in said obtained shot sequence, thus delivering an adapted shot sequence (see step 11 in FIG. 1).

According to the third embodiment previously described, the calculating device computes shot time predictions, from vessel information and the adapted shot sequence, and obtains, by assigned temporal parameters to said shot time predictions, adjusted shot time predictions.

Upon initialization, the aforementioned program code instructions are transferred from the non-volatile memory 61 to the volatile memory 63 so as to be executed by the processor 62. The volatile memory 63 likewise includes registers for storing the variables and parameters required for this execution.

All the steps of the above assignment method can be implemented equally well:
by the execution of a set of program code instructions executed by a reprogrammable computing machine such as a PC type apparatus, a DSP (digital signal processor) or a microcontroller. This program code instructions can be stored in a non-transitory computer-readable carrier medium that is detachable (for example a floppy disk, a CD-ROM or a DVD-ROM) or non-detachable; or
by a dedicated machine or component, such as an FPGA (Field Programmable Gate Array), an ASIC (Application-Specific Integrated Circuit) or any dedicated hardware component.

In other words, the disclosure is not limited to a purely software-based implementation, in the form of computer program instructions, but that it can also be implemented in hardware form or any form combining a hardware portion and a software portion.

At least one embodiment of the disclosure overcomes the above-described different drawbacks of the prior art.

At least one embodiment of the disclosure provides a method for giving flexibility for how and where to shoot, and thus optimizing a survey, especially during a simultaneous shooting.

Although the present disclosure has been described with reference to one or more examples, workers skilled in the art will recognize that changes may be made in form and detail without departing from the scope of the disclosure and/or the appended claims.

What is claimed is:

1. A method for calculating a multi-source seismic survey, wherein said method comprises:
obtaining at least a shot sequence wherein each shot in the shot sequence is associated to one source of said multi-source seismic survey and one source may be associated to more than one shot, and
at least one of the following acts or a combination of the following acts:
assigning at least one spatial parameter, corresponding to a non-constant spatial constraint, to at least one shot in said obtained shot sequence, delivering an adapted shot sequence;
assigning at least one temporal parameter to at least one shot prediction computed from said obtained shot sequence or from said adapted shot sequence, delivering adjusted shot time predictions.

2. The method for calculating a multi-source seismic survey according to claim 1, wherein said non-constant spatial parameters and said temporal parameters are:
predetermined before said survey while computing the preplot, or generated at line submission, or computed during said survey while performing the shot time predictions, or at least a combination of some of these aforesaid situations.

3. The method for calculating a multi-source seismic survey according to claim 1, wherein said temporal parameters are defined by at least two variables corresponding to a type and a value.

4. The method for calculating a multi-source seismic survey according to claim 1, wherein said temporal parameters are defined by at least a couple of indexes, each index referring to a particular shot in said adapted shot sequence.

5. The method for calculating a multi-source seismic survey according to claim 1, wherein said obtaining and assigning are performed at least twice during said survey.

6. A non-transitory computer-readable carrier medium storing a computer program product comprising program code instructions for implementing a method for calculating a multi-source seismic survey, when said program is executed on a computer or a processor, wherein said method comprises:
obtaining at least a shot sequence wherein each shot in the shot sequence is associated to one source of said multi-source seismic survey and one source may be associated to more than one shot, and
at least one of the following acts or a combination of the following acts:
assigning at least one spatial parameter, corresponding to a non-constant spatial constraint, to at least one shot in said obtained shot sequence, delivering an adapted shot sequence;
assigning at least one temporal parameter to at least one shot prediction computed from said obtained shot sequence or from said adapted shot sequence, delivering adjusted shot time predictions.

7. A calculating device for calculating a multi-source seismic survey, wherein said calculating device comprises:
an input module configured to obtain at least a shot sequence wherein each shot is associated to one source of said multi-source seismic survey and one source may be associated to more than one shot, and
at least one of:
a spatial parameter assigning module configured to assign at least one spatial parameter, corresponding to a non-constant spatial constraint, to at least one shot in said obtained shot sequence, delivering an adapted shot sequence;
a temporal parameter assigning module configure to assign at least one temporal parameter to at least one shot prediction computed from said obtained shot sequence or from said adapted shot sequence, delivering adjusted time predictions.
